(19) United States
(12) Patent Application Publication
(10) Pub. No.: US 2026/0355841 A1
(43) Pub. Date: Nov. 12, 2026

(54) SOLDERING APPARATUS HAVING AN EXTRACTION DEVICE FOR EXTRACTING FUMES DURING SOLDERING, AND SOLDERING METHOD FOR AUTOMATED SOLDERING

(71) Applicant: ELMOTEC AG, Kleindöttingen (CH)

(72) Inventor: Raphael Luchs, Wollerau (CH)

(73) Assignee: ELMOTEC AG, Kleindöttingen (CH)

(21) Appl. No.: 19/481,595

(22) PCT Filed: May 6, 2024
(86) PCT No.: PCT/EP2024/062418

§ 371 Date: Nov. 5, 2025

(30) Foreign Application Priority Data
May 6, 2023 (CH) 000487/2023

(51) Int. Cl. B23K 3/08; B23K 3/06; B23K 37/006

(52) U.S. Cl. CPC B23K 3/08; B23K 3/063; B23K 37/006

(57) ABSTRACT

The invention relates to a soldering apparatus (10) having an extraction device (30) for extracting fumes during soldering, the soldering apparatus comprising: a soldering head (20) having at least one soldering material feed (21); and at least one soldering piston (23) which interacts therewith; and a support surface (11), located therebelow, for the soldering points (14) to be soldered in the workpieces (15). The extraction device (30) is connected to an extraction pump via a pipe (13). Arranged in the soldering head (10) is at least one extraction opening (35), located close to the soldering points (14) to be soldered of the workpiece (15), which extraction opening is connected to a conducting member (31) for conducting away the fumes, which is integrated in the soldering head (10) and can be connected to the extraction pump. Forming the conducting member in this way results in a compact design and efficient extraction.

The invention relates to a soldering apparatus having an extraction device for extracting fumes during soldering, and a soldering method for automatic soldering according to the preamble of claim 1 or claim 11.

With soldering apparatuses it is customary to remove the fumes arising during the soldering process by means of an extraction device as completely as possible, as volatilized residues are also contained in this which come from the soldering material consisting of tin, zinc, silver, copper, lead, fluxing agent and/or other constituents, and at most also come from the lacquer coatings, dirt or similar which are present in the metal workpieces to be soldered. In so doing, the intention is to prevent these fumes from being inhaled by operators or from precipitating in the soldering apparatuses by deposits.

The soldering apparatuses comprise, respectively, a soldering head with at least one soldering wire feed or soldering paste feed and at least one soldering piston interacting with the tip of the soldering wire on a movable carriage and a support surface, located below same, for the workpieces to be soldered. The extraction device usually has a flexible hose connected by a pipe to an extraction pump or extraction means, which hose with its extraction opening can be brought into the desired position close to the soldering point manually. This has the disadvantage that these tubes need always be brought into the correct position by hand by the operator and that, additionally, they limit the field of vision to the soldering point. As such a hose is connected independently of the soldering head, it does not follow the adjustment of the soldering head.

The object of the invention is to produce a soldering apparatus with an extraction device which makes it possible to ensure sufficient removal of the fumes in each soldering position of the soldering head without manually actuating the hose. Moreover, with the soldering apparatus, the intention is for at least one workpiece to be able to be provided with one or more soldering points or a number of workpieces each with one or more soldering points automatically, in positionally accurate manner and without hand actuations, preferably with the extraction device which cannot be adjusted by hand.

This object is achieved according to the invention by the features of claim 1 and the features of claim 11, respectively.

According to the invention, there is provided in the soldering head at least one extraction opening, located close to the soldering points to be soldered of the workpieces, which extraction opening is connected to a conducting member for conducting away the fumes, which is integrated in the soldering head and can be connected to the extraction pump or the like.

Very advantageously, the conducting member has a housing forming an annular channel with the at least one connection support and a retaining ring tightly surrounding the housing, with at least one connection support, the connection supports being fluidically connected to the annular channel in the housing. With this development of the conducting member, a compact design of same can be achieved without a hose which requires a protruding space.

In so doing, this conducting member is fastened to the top of the soldering head capable of being removed or exchanged, with the result that it can be produced cost-effectively as an article of daily use, and can be replaced by a new version.

As a further eminent advantage, the housing, designed cylindrical on the outside, is housed, rotationally adjustable, in the retaining ring. This makes possible a faultless functioning of same, in an in particular rotatable soldering head. Expediently, this soldering head is therefore provided with a supporting arm with at least one soldering wire feed and at least one interacting soldering piston in which this supporting arm is rotatably housed by approximately 360° in a base piece of the soldering head preferably about an axis travelling perpendicularly to the support surface and in so doing concentric to the soldering point.

The retaining ring of the conducting member is fastened with its connection support at the upper fixed base piece of the soldering head, while the housing of the conducting member is fixed on the supporting arm reaching through on the inside of same and is held capable of rotation and rotatable by same in the retaining ring.

The invention provides that the extraction opening is designed in this supporting arm of the soldering head, the connection support of the housing reaching up to the extraction opening at the supporting arm, and surrounding same in sealing manner, with the result that the fumes are conducted through the extraction opening and this connection support into the annular channel in the housing and by same through the connection support at the retaining ring to the extraction pump.

The invention is also characterized in that the soldering apparatus is assigned an automated control device comprising a measuring system with a measuring instrument integrated therein, by which the position of the soldering point is ascertained at the workpiece to be soldered, and the soldering head with the soldering wire feed and the soldering piston interacting with same is moved into this position automatically and soldered in controlled manner by the control device. This makes soldering and extraction of the fumes possible without any manual manipulations and the result of this is a very high degree of securely soldered points, which permanently produce these electric solder connections, as predetermined, and no unsoldered or only insufficiently soldered points are produced.

In so doing, the invention provides that a camera and/or a sensor unit of the measuring instrument arranged in the soldering head reaches through the cavity of the housing of the extraction device and with its front side a direct access to the soldering point is produced. In so doing, this compactness of the soldering head according to the invention of the soldering apparatus is shown to be optimal.

The invention, and further advantages of same, are explained in more detail below using exemplary embodiments with reference to the drawings. In these:

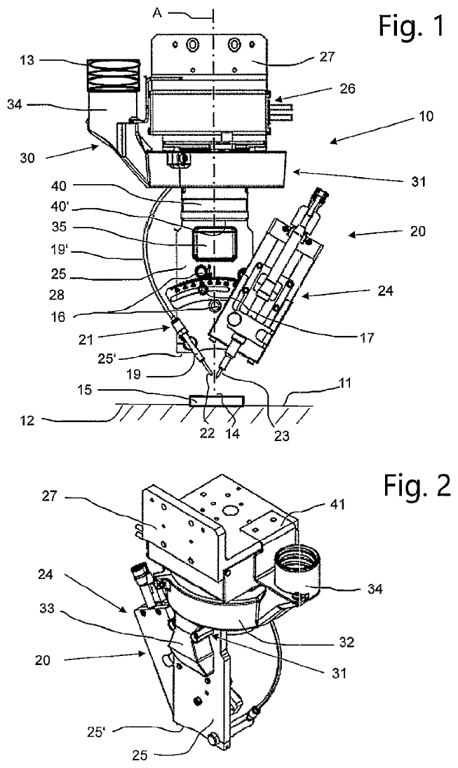

FIG. 1 is a front view of a soldering apparatus with a soldering head and with an extraction device according to the invention and integrated in same;

FIG. 2 is a perspective side view of the soldering apparatus in which the rear side is apparent;

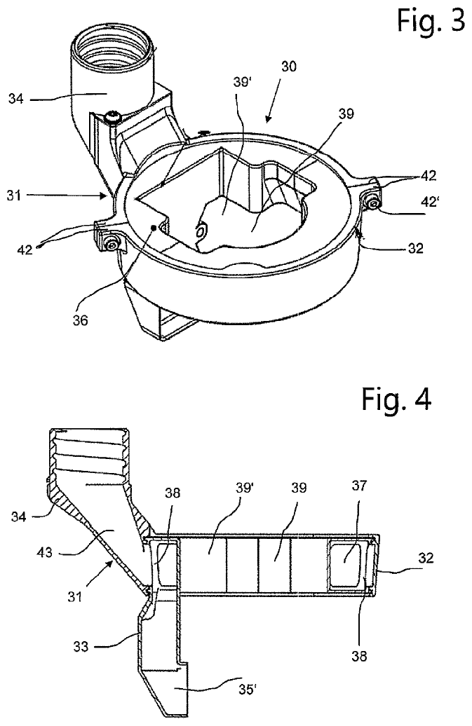

FIG. 3 is a perspective view of the extraction device according to the invention according to FIG. 1 without the soldering head of the soldering apparatus; and

FIG. 4 is a longitudinal section through the extraction device according to FIG. 3 without the soldering head.

FIG. 1 and FIG. 2 show a soldering apparatus 10 with a soldering head 20, which are usually adjustably arranged on a machine frame, not shown in more detail, in a closed cell, for example surrounded by inspection windows during operation, for producing the soldering points. A support surface 11 for the workpiece(s) 15 is indicated below the soldering head 20, which workpieces abut directly against a workpiece table or respectively can be held in a clamping device or the like.

Such a soldering apparatus 10 is suitable for producing solder connections on different types of workpieces 15 in which one or more electric connection points need to be produced by soldering. Thus these workpieces 15 can for example be printed circuit boards, chips, electronics components, wires, electric connection elements or the like.

The soldering apparatus 10 has a soldering head 20 with a soldering wire feed 21 and a soldering piston 23 interacting with same, and the support surface 11 located thereunder, for the workpieces 15 to be soldered. The soldering piston 23 is held movable back and forth on a carriage 24. The soldering head 20 is composed of a plate-shaped supporting arm 25, an extraction device 30 for extracting fumes, a holder 26 of the supporting arm 25 and a base piece 27 for fastening the soldering head 20 to an adjusting unit or the like.

The adjusting unit, not shown in more detail, is preferably equipped with adjusting means movable in x-, y- and z direction and associated guide rails, which make it possible for the soldering head 20 to be moved automatically in these three directions and positioned in predetermined soldering positions. The soldering head 20 is preferably attached with its holder 26 of the supporting arm 25 to the adjusting means, movable in vertical z direction on a guide rail. Moreover, the supporting arm 25 of the soldering head 20 is preferably rotatably housed by approximately 360° preferably about an axis A travelling perpendicularly to the support surface 11 concentric to the soldering point 14 in the holder 26.

Furthermore, an aligning apparatus 28 is also shown, with an angular scale 29 for adjusting the angle of the carriage 24 and with it the front-side soldering piston 24, by means of which the soldering piston 24 and soldering wire 22 running parallel to the image plane can be set at an angle with respect to one another in order to achieve optimum soldering. This angular scale 29 is fastened to the 24 and can be pivoted, in aligning manner, about an axis at the tip of the soldering piston by loosening a screw 17 in guide elements 16 together with the carriage.

Before each soldering, the soldering wire 22 is moved against the soldering piston 24 by this soldering wire feed 21 with a specific stroke length in its axial direction, whereas the carriage 24 moves in front of the soldering piston 24 in its axial direction by a specific stroke when the soldering head 20 is brought into soldering position, and after soldering the soldering piston 24 is moved backwards by the carriage 24 by the same stroke. The soldering wire feed 21 comprises a hose 19′ and a guide sleeve 19 held pivotable on the soldering head, through which the soldering wire 22 is guided. The strokes of the soldering piston 24 and the soldering wire 22 take place due to a control device of the soldering apparatus.

According to the invention, arranged in the soldering head 20 is at least one extraction opening 35, located close to the soldering points to be soldered of the workpieces 15, which extraction opening is connected to a conducting member 31 for conducting away the fumes, which is integrated in the soldering head 20 and can be connected to the extraction pump.

In so doing, extraction can take place without manual adjustment of a flexible hose and automatic soldering is made possible. The extraction pump-not shown-is placed below the soldering apparatus or outside of the machine frame via a pipe 13 leading away from the conducting member 31 in the machine frame. However, it could also be mounted elsewhere.

As can also be seen from FIG. 3 and FIG. 4, this conducting member 31 is provided with a connection support 33 connected to the extraction opening 35 in sealing manner, and a connection support 34 for the pipe 13 to the extraction pump. Preferably, this conducting member 31 consists of a housing 36 forming an annular channel 37 with the connection support 33 and a retaining ring 32 tightly surrounding the housing 36, with the connection support 34, the connection supports 33, 34 being fluidically connected to the annular channel 37 in the housing 36. For this purpose, the housing 36 is open and cylindrical on the outer periphery, and designed with stop ridges 38 as reinforcement. The connection support 34 of the housing 36 reaches, on the rear side of the supporting arm 25, up as far as the extraction opening 35 and surrounds same in sealing manner, with the result that the fumes can be conducted through the extraction opening 35 and the opening 35′ below at the connection support 33 into the annular channel 37 in the housing 36, and conducted from this by the connection support 34 at the retaining ring 32 and through the pipe 13 to the extraction pump.

The housing 36 provided with the annular channel 37 on the outside is designed with a cavity 39 internally in the centre, through which cavity the soldering head 20 reaches through with its plate-shaped supporting arm 25. The cavity 39 is occasionally formed by a recess 39′, which is designed to be rectangular in transverse section, and this supporting arm 25 can be inserted therein in form-locking manner.

The retaining ring 32 is fixed with its connection support 34 to the base part 27 at the top holder 26 of the supporting arms 25 by a fastening element 41. Due to the rotatability of the supporting arm 25, as mentioned above, the housing 36 of the conducting member 31 is brought along during rotation of same, whereas the retaining ring 32 fixed to the holder 26 remains stationary, and unrotatable. Therefore, within the framework of the invention it is provided that the housing 36 is stored rotationally adjustable in the retaining ring 32. The retaining ring 32 consists of two half rings which are detachably fastened to one another on the outside of the cylindrically designed housing 36 by two flaps 42, each capable of being connected in pairs by a screw 42′ each, the one connection support 34 being provided with a transverse opening 43 on the one half ring, which opening opens inwards into the annular channel 37 of the housing 36. These half rings are fastened to one another such that the housing can rotate inside same and does not stick. This design of the retaining ring 32 makes it possible for it to be dismounted simply from the housing 36 to exchange the extraction device 30 and also for the housing 36 to be capable of being extracted easily from this supporting arm by removing the supporting arm 25 from the holder 26. Self-evidently, this retaining ring could also be made in one piece, and capable of being placed over the housing.

The plate-shaped supporting arm 25 is extended with its underside 25′ to approximately the height of the soldering wire 22 or the soldering piston 23 above the support surface 11 and is located at a short distance behind the soldering wire. In so doing it is achieved that the fumes extracted during soldering at the extraction opening 35 are guided at the front along this plate-shaped supporting arm 25 and thus a partial shielding and guiding of the fumes is caused. As required, the extraction pump can be switched on and back off again with every soldering process or left to run without being switched off when solderings take place one after the other. Moreover, the invention is characterized in that the soldering apparatus 10 is assigned a control device comprising a measuring system with a measuring instrument integrated therein, by which the position of the soldering point 14 is ascertained, preferably by a marking at the workpiece 15 to be soldered, and the soldering head 10 with the soldering wire feed 21 and the soldering piston 23 interacting with same is moved into this position automatically and soldered in controlled manner by the control device. In so doing, automatic soldering without manual involvement is made possible, and imprecisions of the position of the workpiece 15 to be soldered are corrected automatically.

The measuring instrument integrated in the soldering apparatus 10 has at least one camera 40 arranged in the soldering head 20, which camera is aligned to the soldering point 14 and detects this by photographs. In so doing, image coordinates are produced, and the at least one soldering position of the workpiece surface is ascertained and determined in x-and y-direction by means of an evaluation unit on the workpiece surface. The soldering head 20, and thus the soldering wire feed 21 and the soldering piston 23, are guided to this measured soldering position automatically by the control device and the soldering is carried out in controlled manner on the basis of this measurement.

The camera 40 of the measuring instrument arranged in the soldering head 20 is fastened in the holder 26 and reaches through the cavity 39 in the centre of the housing 36 of the extraction device 30. A direct view of the soldering point 14 between the soldering wire feed 21 and the soldering piston 23 is thus created with the front side 40′ of the camera 40 without any objects being located therebetween. Advantageously, this camera 40 is equipped with a flash unit, in order to be able to record the soldering point 14 precisely.

As a further additional function, the measuring instrument can record an identification, given on the upper visible surface of the workpiece 15 as a barcode or similar, together with the soldering detected by the camera 40, and store same in a database. This makes it possible for the produced solderings on identified workpieces to be traced in order to meet known manufacturing standards.

As a further stage of the automation of the invention, the soldering detected by the camera 40 of the measuring instrument can be detected by a picture or image sequences as actual state and image coordinates of same produced. These actual states can then be compared with a target value of the solder and evaluated in order at least to find out from this whether each of the solderings has taken place within the established tolerance values. In so doing, the recordings of the camera 40 as imaging unit are stored and evaluated by calculations by means of a software program and subsequent analyses thereof. The subsequent solderings can then be modified and improved with these evaluations.

The invention is sufficiently displayed with the above exemplary embodiments. It could still be explained by further variants.

Instead of a soldering wire as soldering material, known soldering pastes could be used which respectively are fed in portions with a dosage apparatus to the soldering point, these likewise being able to be arranged up to above the soldering point by at least one feed pipe.

The extraction opening could self-evidently also be arranged as shown also at another side of the soldering head, such as for example on the underside, directly behind the soldering piston, or two or more such extraction openings could be provided above and next to one another, in or adjacent to this supporting arm. This also depends on the height or width of the workpiece.

In principle, an angled attachment of a solid or flexible hose or a square tube piece could be connected tightly in this extraction opening on the front side of the supporting arm in order that the extraction opening could still be capable of being positioned even closer to a soldering point, depending on the dimensions of the workpiece.

Moreover, the conducting member could also be designed other than as explained. The connection support could also be produced as separate parts which would be fastened to the housing or to the supporting ring or to the soldering head.

Instead of being plate-shaped, the supporting arm 25 could also be designed differently in shape, such as for example tubular, with a rectangular cross-section, with no connection support being necessary on the extraction opening, but instead this being carried out by the supporting arm itself.

In principle, the extraction device could be arranged in a soldering apparatus which would be provided not with a supporting arm with the soldering wire and the soldering piston which would be rotationally adjustable about the axis, but only with this connection support without the housing with the annular channel.

Camera 40 could also be an infrared camera which for example works using infrared radiation and by means of which images with visualisations of the temperature ranges could be produced.

As mentioned, at least one sensor unit working for example with laser beams or a combination of these measuring systems could be used. In so doing, the soldering points could be detected as images during and/or immediately after the soldering, in which a visualisation of the temperature ranges would be capable of being established. It could thereby be established the extent to which the soldering points have been loaded with the heated and liquefied solder material.

1. Soldering apparatus having an extraction device for extracting fumes during soldering, the soldering apparatus (10) having a soldering head (20) having at least one soldering material feed (21) and at least one soldering piston (23) which interacts therewith; and a support surface (11), located therebelow, for the soldering points (14) to be soldered in the workpieces (15); the extraction device (30) being connected to an extraction pump or the like via a pipe (13), characterized in that arranged in the soldering head (10) is at least one extraction opening (35), located close to the soldering points (14) to be soldered of the workpieces (15), which extraction opening is connected to a conducting member (31) for conducting away the fumes, which is integrated in the soldering head (10) and can be connected to the extraction pump.

2. Soldering apparatus according to claim 1, characterized in that the conducting member (31) for guiding away the fumes, which is fastened to the top of the soldering head (10) and can be removed or exchanged, is provided with at least one support connection (33) which is connected in sealing manner to the at least one extraction opening (35) and at least one connection support (34) for the pipe (13) to the extraction pump.

3. Soldering apparatus according to claim 2, characterized in that the conducting member (31) has a housing (36) forming an annular channel (37) with the at least one connection support (33) and a retaining ring (32) tightly surrounding the housing (36), with at least one connection support (34), the connection supports (33, 34) being fluidically connected to the annular channel (31) in the housing (36).

4. Soldering apparatus according to claim 3, characterized in that the housing (36), designed cylindrical on the outside, is housed, rotationally adjustable, in the retaining ring (32).

5. Soldering apparatus according to claim 4, characterized in that the retaining ring (32) consists of two half rings which are detachably fastened to one another on the outside of the cylindrically designed housing (36), the one connection support (34) being provided with a transverse opening (43) on the one half ring, which opening opens inwards into the annular channel (31) of the housing (36).

6. Soldering apparatus according to claim 1, wherein the housing (36) of the conducting member (31) is provided on the inside with a cavity (39) through which the soldering head (10) reaches with a plate-shaped supporting arm (25) with the extraction opening (35) provided therein, the connection support (33) of the housing (36) reaching on the rear of the supporting arm (25) as far as the extraction opening (35) and surrounding the extraction opening (35) in sealing manner, with the result that fumes are guided through the extraction opening (35) and this connection support (33) into the annular channel (37) in the housing (36) and from the annular channel (37) through the connection support (34) at the retaining ring (32) via a pipe (13) to the extraction pump.

7. Soldering apparatus according to claim 1, wherein the retaining ring (32) is fixed with its connection support at the upper fixed holder (26) of the soldering head (10), while the housing (36) of the conducting member (31) is fixed by the supporting arm (25) reaching through the inside of the supporting arm (25), this supporting arm (25) being rotatably housed by approximately 360° about an axis (A) travelling perpendicularly to the support surface (11) concentric to the soldering point (14) in the holder (26) and thus the housing (36).

8. Soldering apparatus according to claim 1, wherein the supporting arm (25) extends with its underside (25′) above the support surface (11) as far as the height of the soldering wire (22) and is thus also at a smaller distance behind the soldering wire (22), with the result that a partial shielding and guiding of fumes arising at the soldering point (14) is caused.

9. Extraction device for a soldering apparatus according to claim 1, wherein the extraction device (30) is provided with a conducting member (31) with at least one connection support (33) with at least one extraction opening (35) for guiding away fumes, and at least one connection support (34) for connection to a pipe (13) to an extraction pump.

10. Extraction device according to claim 9, characterized in that the conducting member (31) has a housing (36) forming an annular channel (37) with the at least one connection support (33) and a retaining ring (32) tightly surrounding the housing, with the at least one connection support (34), the connection supports (33, 34) being fluidically connected to the annular channel (37) in the housing (36) and the housing (36) being housed, rotationally adjustable, in the holding ring (32).

11. Soldering method preferably with a soldering apparatus according to claim 1, wherein the soldering apparatus (20) is assigned a control device comprising a measuring system with a measuring instrument integrated therein, by which the position of the soldering point (14) is ascertained, by a marking at the workpiece (15) to be soldered, and the soldering head (20) with the soldering wire feed (21) and the soldering piston (23) interacting with same is moved into this position automatically and soldered in controlled manner by the control device.

12. Soldering method according to claim 11, characterized in that the measuring instrument integrated in the soldering apparatus (10) has at least one camera (40) and/or a sensor unit arranged in the soldering head (20) which is aligned to the soldering point (14) and detects this by photographs, by which image coordinates are produced and the at least one soldering point (14) on the workpiece surface is ascertained and determined in x-and y-direction by means of an evaluation unit, and from this the soldering wire feed (21) and the soldering piston (23) of the soldering head (20) are guided automatically to this soldering position by the control device and the soldering is carried out in controlled manner.

13. Soldering method according to claim 12, characterized in that the camera (40) of the measuring instrument, arranged in the soldering head (20), is fastened in the holder (26) and reaches through the cavity (39) of the housing (36) of the extraction device (30), a clear view of the soldering point being achieved with its front side (40′) without any object being located therebetween.

14. Soldering method according to claim 11, wherein the identification indicated on the upper visible surface of the workpiece (15) is ascertained by the measuring instrument together with the solder detected by the camera (40) and stored in a database in order to make it possible for the solderings produced to be traced.

15. Soldering method according to claim 11, wherein using a photograph or sequence of images, the soldering detected by the camera (40) of the measuring instrument is compared, as actual state, with a target value of the solder and evaluated in order at least to find out whether each of the solderings has taken place within established tolerance values.
